(19) United States
(12) Patent Application Publication
(10) Pub. No.: US 2025/0225061 A1
(43) Pub. Date: Jul. 10, 2025

(54) AUTOMATED MENU TESTING

(71) Applicant: DELL PRODUCTS L.P., Round Rock, TX (US)

(72) Inventors: Xiaowei Shen, Shanghai (CN); Qin Zhang, Shanghai (CN); Xiaoxuan Dong, Shanghai (CN); Tianyu Zheng, Shanghai (CN); Ling Xu, Shanghai (CN)

(21) Appl. No.: 18/585,998

(22) Filed: Feb. 23, 2024

(30) Foreign Application Priority Data
Jan. 8, 2024 (CN) 202410029668.2

(51) Int. Cl. G06F 11/36

(52) U.S. Cl. CPC G06F 11/3688

(57) ABSTRACT

Subsequent to initializing a frame buffer associated with a menu, an information handling system decomposes content of the frame buffer into a text space, a foreground space, and a background space. The system navigates the menu to a key node using a control key, wherein the key node includes an expected text and an expected attribute. The system also matches a text and an attribute of a current element to the expected text and the expected attribute, wherein the text is from the text space, and wherein the attribute is a foreground color from the foreground space or a background color from the background space.

### FIELD OF THE DISCLOSURE

The present disclosure generally relates to information handling systems, and more particularly relates to automated menu testing.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

Subsequent to initializing a frame buffer associated with a menu, an information handling system decomposes content of the frame buffer into a text space, a foreground space, and a background space. The system navigates the menu to a key node using a control key, wherein the key node includes an expected text and an expected attribute. The system also matches a text and an attribute of a current element to the expected text and the expected attribute, wherein the text is from the text space, and the attribute is a foreground color from the foreground space or a background color from the background space.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of an environment for automated menu testing, according to an embodiment of the present disclosure;

FIGS. 3 and 4 are flowcharts of methods for automated menu testing, according to an embodiment of the present disclosure;

FIG. 5 is a table for automated menu testing, according to an embodiment of the present disclosure;

FIG. 6 is a table that maps a color to a color code, according to an embodiment of the present disclosure;

FIG. 7 is a diagram of a target menu, according to an embodiment of the present disclosure;

FIG. 8 is a diagram of a text space that includes text associated with a target menu, according to an embodiment of the present disclosure;

FIG. 9 is a diagram of a foreground space that includes foreground color codes associated with the target menu, according to an embodiment of the present disclosure;

FIG. 10 is a diagram of a background space that includes background color codes associated with a target menu, according to an embodiment of the present disclosure;

FIGS. 11 and 12 are diagrams of a target menu, according to an embodiment of the present disclosure;

FIG. 13 is a diagram of text in a text space associated with a target menu, according to an embodiment of the present disclosure;

FIG. 14 is a diagram of a foreground space that includes foreground colors associated with a target menu, according to an embodiment of the present disclosure;

FIG. 15 is a diagram of a background space that includes background color codes associated with a target menu, according to an embodiment of the present disclosure;

FIG. 16 is a diagram of a target menu with a sub-menu, according to an embodiment of the present disclosure;

FIG. 17 is a diagram of text associated with a target menu, according to an embodiment of the present disclosure;

FIG. 18 is a diagram of a foreground space that includes foreground color codes associated with a target menu, according to an embodiment of the present disclosure; and

FIG. 19 is a diagram of a background space that includes background color codes associated with a target menu, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

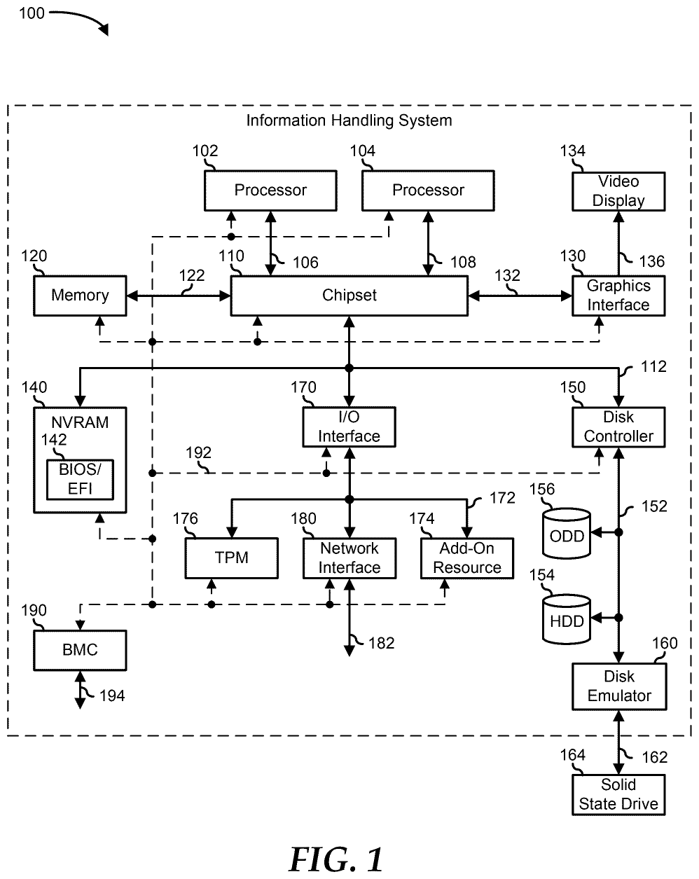

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a USB or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Conventional user interface (UI) testing is done manually by a human tester who may perform a set of operations to verify that a UI is behaving correctly. Automated UI testing is more efficient. However, typical UI automation tests of menus use a pre-defined menu map. Using the pre-defined menu map, an automation test library can calculate a path to the target item and generate an ordered series of navigation instructions. However the path can be broken if a cursor is not at the right starting position in the menu, which may happen during regression testing. In addition, a pre-defined menu map lacks flexibility. For example if an element is added to or removed from the menu, then the pre-defined menu map is broken and may need to be updated. This is an issue because the menu typically changes during the development process. To address these and other concerns, the present disclosure provides a system and method for key node-based menu navigation. This allows UI menu automation testing without using the pre-defined map. This allows an element to be added and subtracted from the menu without the tester needing to update the test case. Hence, the present disclosure improves the technological field associated with UI automation testing by improving the software-based ability to verify that the UI is behaving correctly while minimizing updates to test cases with changes to the menu.

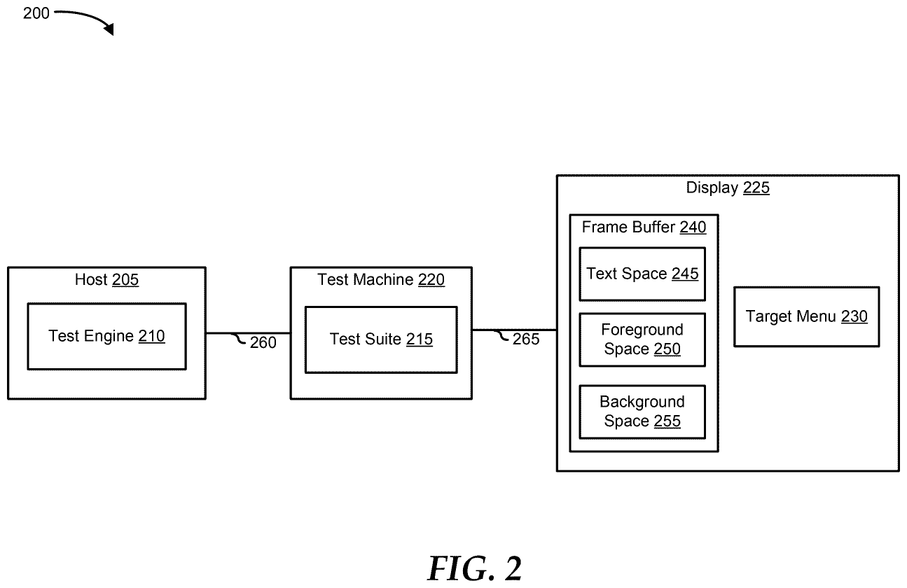

FIG. 2 shows an environment 200 for automated menu testing. Environment 200 includes a host 205, a test machine 220, and a display 225. Display 225 includes a target menu 230 and a frame buffer 240. Frame buffer 240 includes a text space 245, a foreground space 250, and a background space 255. Host 205 is communicatively coupled to test machine 220 via at least one connection or interface, such as a communication interface 260. Similarly, test machine 220 may be communicatively coupled to display 225 via at least one connection or interface, such as a communication interface 265. One or both communication interfaces 260 and 265 may be a serial interface, network interface, or similar. In one example, communication interfaces 260 and/or 265 may be an IEEE 1394, a USB, or the like, wherein data packets may be sent via a serial stream. Although FIG. 2 shows only one test machine 220, it should be understood that host 205 can support a large number of test machines. In addition, both host 205 and test machine 220 may be similar to information handling system 100 of FIG. 1.

Host 205 may include a test engine 210 which is configured to send an instruction to test machine 220 to control the operation of test machine 220. For example, test engine 210 may send at least one instruction or test case in a test suite 215 to test machine 220 to control how to move the position of a cursor on a target menu 230 which is displayed at display 225. Display 225 may be any suitable system, device, or apparatus configured to display alphanumeric data, images, video content, and/or graphical user interfaces on a display screen. Display 225 may include any type of light-emitting diode (LED), organic LED (OLED), liquid crystal display (LCD), electroluminescence (EL), or other display technology. Frame buffer 240 of a memory, may be partitioned into three separate spaces or buffers that include text space 245, foreground space 250, and background space 255. Text space 245 may be used to store text data. Foreground space 250 may be used to store foreground data. Background space 255 may be used to store background data. The background, foreground, and text image data may be used as overlay image planes to generate image data that is output to display 225 of test machine 220. Each position and text data in the target menu may be associated with a background color and a foreground color. Although display 225 is shown separately from test machine 220, display 225 may be integrated into test machine 220. In addition, frame buffer 240 may be part of test machine 220 as well.

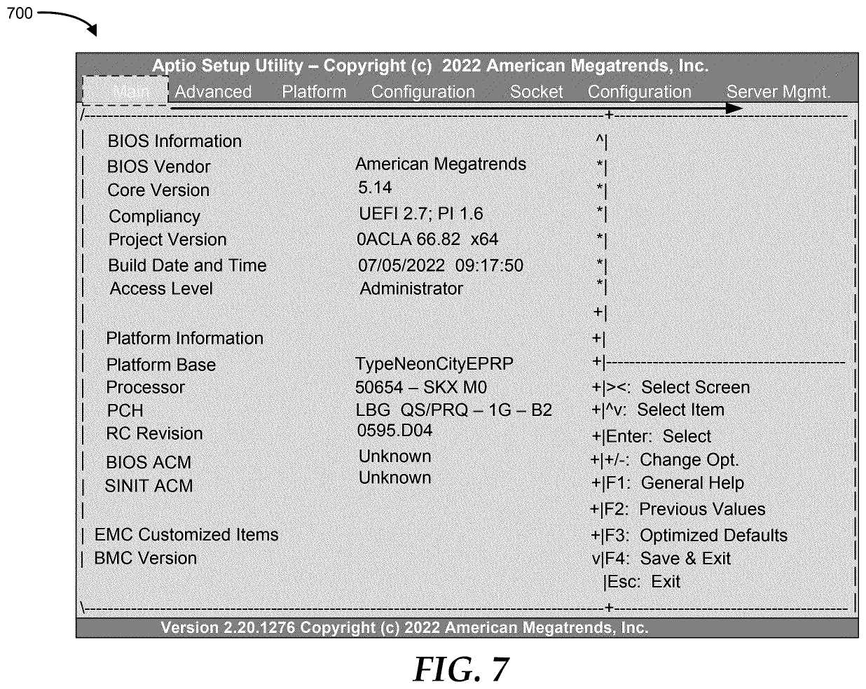

Target menu 230 may be a menu in an interface of an application or a sub-interface. For example, target menu 230 may be similar to target menu 700 of FIG. 7. A test suite provided by a test management system may include a suite of test cases that navigates target menu 230, detects a key node, selects an option in target menu 230, detects a selection of an option, etc. It should be understood that each test case may include at least one or a combination of test steps. Target menu 230 can be traversed using control keys that include navigation keys which are also referred to as direction keys. For example, to navigate target menu 230 horizontally, a “left” or “right” key may be used while to navigate target menu 230 vertically, an “up” or “down” key may be used. For example, when the “up” arrow on a keyboard is used, a highlighted region of target menu 230 may move to the next region above the current location of the highlighted region. Likewise, when a “down” arrow on the keyboard is used, the highlighted region may move to the next region below the current location of the highlighted region. Control keys may also be used to perform an operation while navigating target menu 230. For example, the “Ctrl+F5” keys may be used to refresh target menu 230 while an “escape” key may be used to exit target menu 230. In another example, an “F1” control key may be used to enable a help menu. In yet another example, an “enter” key may be used to move focus between elements. In addition, other control keys may be defined by a user.

Those of ordinary skill in the art will appreciate that the configuration, hardware, and/or software components of environment 200 depicted in FIG. 2 may vary. For example, the illustrative components within environment 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

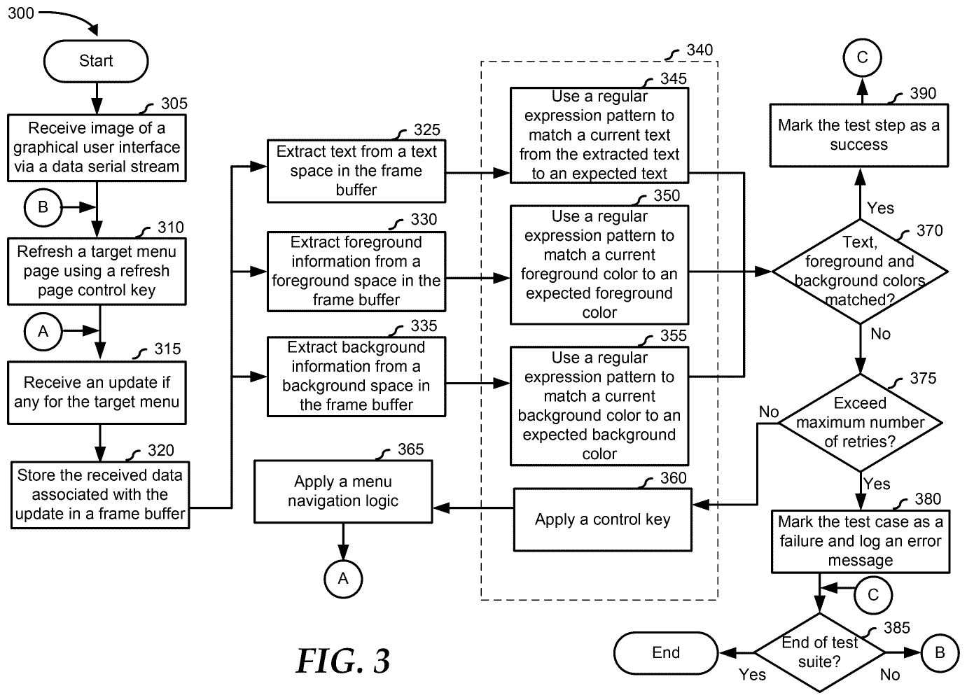

FIG. 3 shows a flowchart of a method 300 for automated menu testing. Method 300 may be configured to match text, foreground, and background colors with a target element in a target menu by using key node-based menu navigation. The key node is a menu element that can be identified and/or visited while navigating the target menu. Because a direction, such as whether to move in a vertical or horizontal direction, may be bound to the key node, method 300 allows for a simple and flexible way of navigating the target menu. Method 300 may be performed by one or more components of environment 200 of FIG. 2, such as test engine 210. While embodiments of the present disclosure are described in terms of environment 200 of FIG. 2, it should be recognized that other systems may be utilized to perform the described method.

Method 300 typically starts at block 305, wherein a target menu for testing is received by a test machine. The method proceeds to block 310 where the target menu may be refreshed using a refresh page control key. The target menu, such as a BIOS setup menu, may be rendered in an American National Standards Institute (ANSI) compatible display via a serial stream. Because changes in content may be streamed through a serial interface, the target menu is generally not refreshed during navigation. Accordingly, the method may trigger a refresh of the target menu using the fresh control key, such as an “F1” key, such that all of the elements in the target menu may be updated, which may also put a cursor in a starting point of the target menu. The method proceeds to block 305.

At block 315, the method may receive an update based on a change to one or more elements of the target menu if any. The change may be based on the refresh to the target menu page applied at block 310. The change may also be based on the application of a control key, such as at block 360. The method proceeds to block 320, where data associated with the target menu includes an update if any may be stored in a frame buffer. The frame buffer may be configured to interpret an ANSI character stream to a frame. The frame buffer may be initialized for a whole page, such as during a refresh. In addition, the frame buffer may be updated by an incremental stream of content. Once a frame buffer is initialized and/or updated, the frame buffer may be decomposed into three spaces, a text space, a foreground space, and a background space. A change in the target menu or location of the cursor can be reflected in the three spaces.

Information in the foreground and background space provides additional detail than a snapshot image of the target menu. For example, the foreground space includes a foreground color associated with the text. The background space includes a background color associated with the text. The information along with expected text may be used in navigating the target menu to reach a target position instead of just using the expected text and/or a menu map. For example, the additional information may help determine the location of the cursor, which items are non-selectable, whether the items are in the top menu, etc. The method may proceed to blocks 325, 330, and 335.

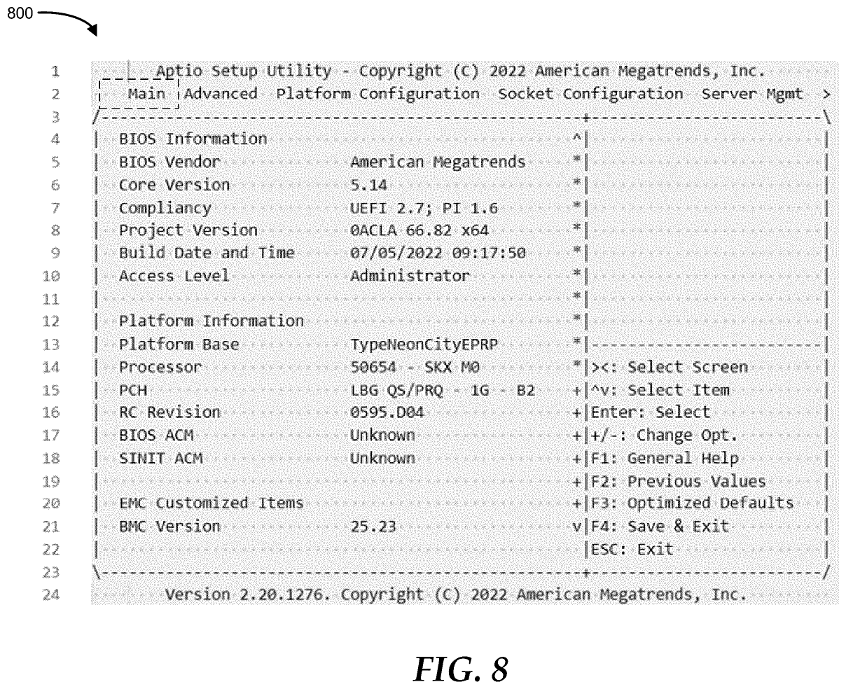

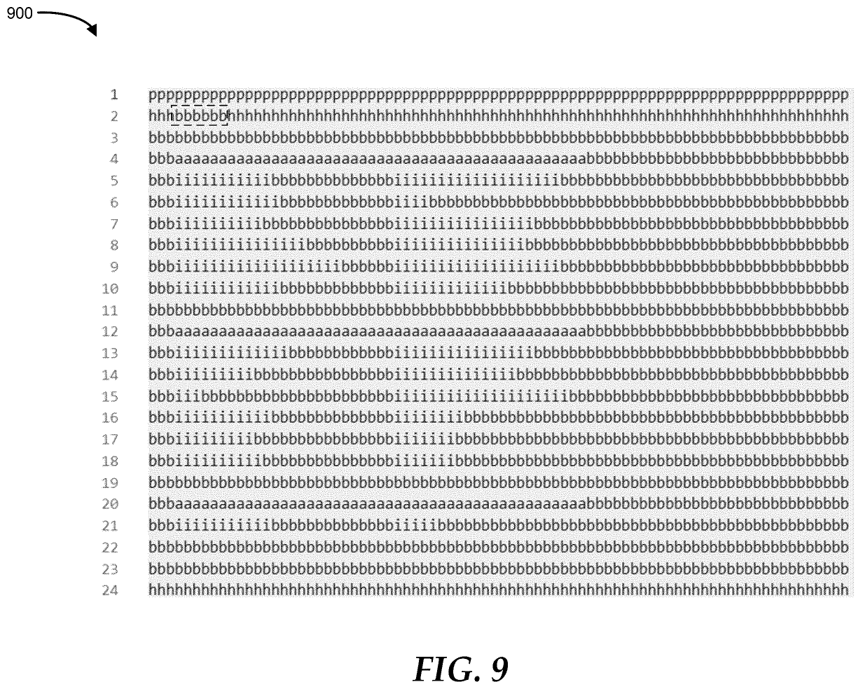

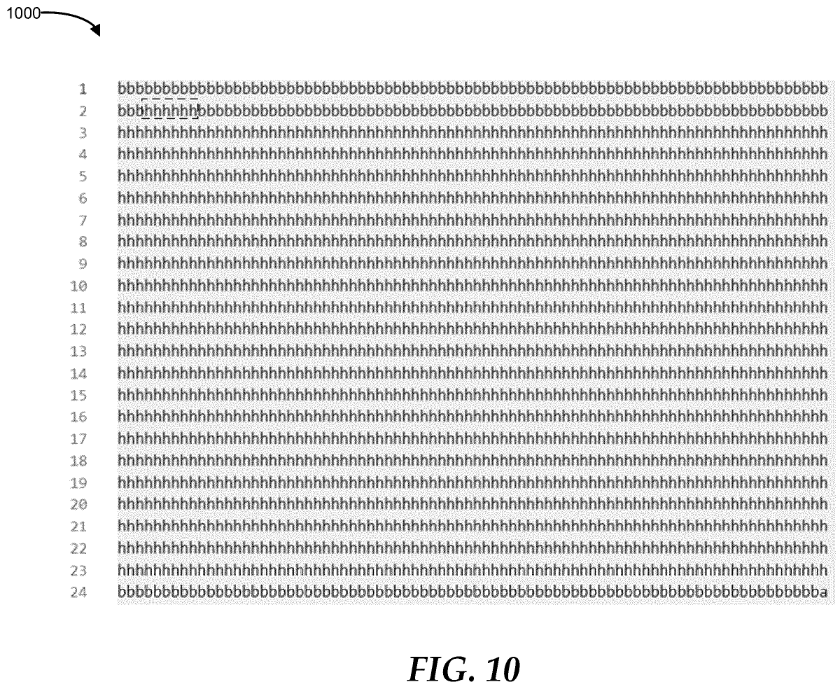

At block 325, the method may extract text from the text space in the frame buffer as depicted in FIG. 8. At block 330, the method may extract foreground information from the foreground space in the frame buffer as depicted in FIG. 9. At block 335, the method may extract background information from the background space in the frame buffer, as depicted in FIG. 10. The method may proceed to block 340.

At block 340, the method may perform a test step as part of a test case in a test suite. In particular, the method may perform blocks 345, 350, 355, and 360. For example, block 340 may be a test step that includes matching a key node to current content, wherein the key node includes expected text, background, and foreground colors. In particular, the method may use regular expression patterns to match the content in the text, foreground, and background spaces, such as depicted in a table 600 of FIG. 6. In one example, the test step may be represented as a row in table 600. The test step may be performed to capture an element in the target menu, such as selected items, displayed items, pop-up windows, etc.

At block 345, the method may use a regular expression to match the extracted text to an expected text. At block 350, the method may use a regular expression pattern to match a current foreground color to an expected foreground color. At block 355, the method may use a regular pattern expression to match a current background color to an expected background color. The method may proceed to decision block 370.

At decision block 370, the method may determine whether the extracted text, foreground, and background colors match the expected text, foreground, and background colors at blocks 345, 350, and 355. If the current text, foreground, and background colors match the expected text, foreground, and background colors, then the “YES” branch is taken, and the method proceeds to block 390. If the current text, foreground, and background colors do not match the expected text, foreground, and background colors, then the “NO” branch is taken, and the method proceeds to decision block 375. At block 390, the method may mark the test step as a success. Information associated with the test step may be logged. If the test steps of a test case are all logged as successful, then the test case is successful. The method may proceed to decision block 385.

At decision block 375, the method may determine whether a maximum number of retries threshold has been exceeded. If the maximum number of retries has been reached, then the “YES” branch is taken, and the method may proceed to block 380. If the maximum number of retries has not been reached, then the “NO” branch is taken, and the method may proceed to block 360.

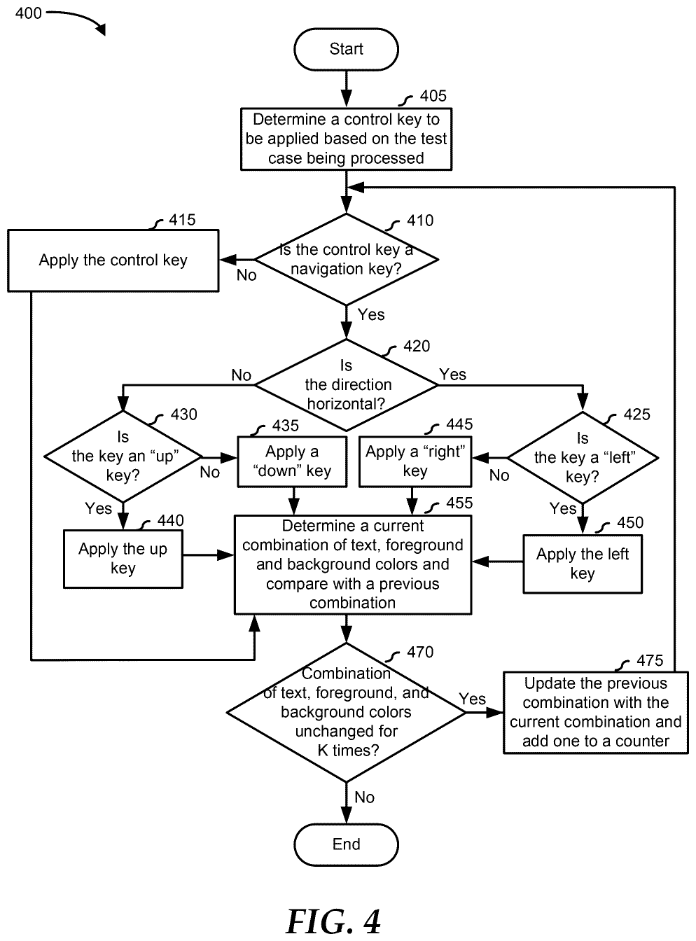

At block 360, the method may apply a control key as indicated in the test step or test case. For example, the method may apply a horizontal or vertical navigation key. In particular, the method may apply a left, right, up, or down key. In another example, the method may apply an escape key. The method may proceed to block 365. At block 365, the method may apply a menu navigation logic, which is illustrated in detail in FIG. 4. The method may proceed to block 315.

At block 380, the method may mark the test case as a failure and log an error message. If at least one of the test steps fails, then the test case fails. The method may proceed to decision block 385. At decision block 385, the method may determine whether the test case was the last test case of the test suite. If the test case is the last test case of the test suite, then the “YES” branch is taken, and the method ends. If the test case is not the last test case of the test suite, then the “NO” branch is taken, and the method proceeds to block 310.

FIG. 4 shows a flowchart of a method 400 which is a more detailed illustration of block 365 of method 300 of FIG. 3. Method 400 may be configured to function as a feedback loop which allows the continuation of sending control keys until a target menu item is reached, which completes a test case or the cursor is stuck horizontally or vertically at the end of the menu, wherein the maximum number of retries has been reached. Method 400 may be configured to navigate non-circular menus. In a circular menu, when a cursor reaches the end of the target menu, either by moving horizontally or vertically, the cursor may navigate back to the start of the menu. However, in non-circular menus, the cursor may be stuck at the end of the target menu. Thus, a maximum number of retries may be used to identify whether the cursor may have been stuck at the end of the target menu. The maximum number of retries may be a pre-defined threshold in a test case. Each target element in the menu may be associated with a different threshold.

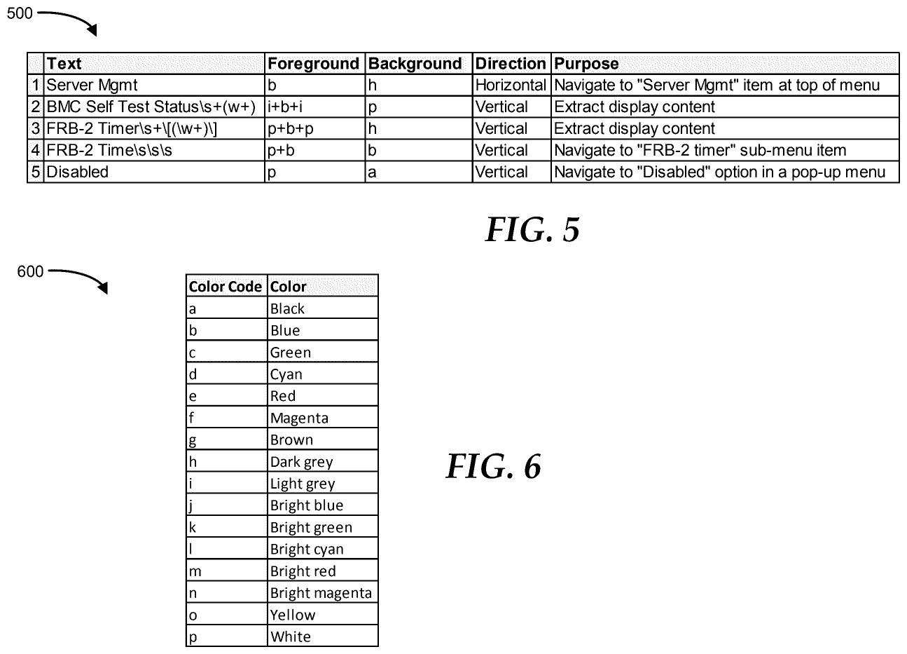

Method 400 typically starts at block 405 where the method may determine a control key to be applied based on the test case being processed, such as depicted in a direction column of table 500 of FIG. 5. The method may proceed to decision block 410. At decision block 410, the method determines whether the control key is a navigation key. If the control key is a navigation key, then the “YES” branch is taken, and the method proceeds to decision block 420. If the control key is not a navigation key, then the “NO” branch is taken, and the method proceeds to block 415. At block 415, the control key may be applied. The control key may be a single key or a combination of keys adapted to perform an action. Examples of the control key may include a Ctrl, Alt, Esc key, or similar. The method may proceed to block 455. According to decision block 420, the method may determine whether a direction associated with the navigation key is horizontal. If the direction of the navigation key is horizontal, then the method proceeds to decision block 425. If the direction of the navigation key is not horizontal, then the method proceeds to decision block 430.

At decision block 425, the method may determine whether the navigation key is a left key. If the navigation key is the left key, then the “YES” branch is taken, and the method proceeds to block 450 where the left key is applied. If the navigation key is not the left key, then the “NO” branch is taken, and the method proceeds to block 445 where the right key is applied. The method may proceed to block 455. The method may proceed to block 455. At decision block 430, the method may determine whether the navigation key is an up key. If the navigation key is the up key, then the “YES” branch is taken, and the method proceeds to block 440 where the up key is applied. If the navigation key is not the up key, then the “NO” branch is taken, and the method may proceed to block 435 where the down key may be applied. The method may proceed to block 455.

At block 455, the method may determine a current combination of text, foreground, and background colors. The method may compare the current combination of text, foreground, and background colors with a previous combination of text, foreground, and background colors. If this block is included in the first step of a test case, then the previous combination of text, foreground, and background colors may have been initialized to values at the start of the test case and a numeric “K” may have been set to a pre-defined maximum number of retries for the current test case. Each test case may have a different pre-defined maximum number of retries. In addition, at the start of the test case, a counter may have been set to zero. The method may proceed to decision block 470.

At decision block 470, the method may determine whether the combination of text, foreground, and background colors are unchanged for K times. If the combination of text, foreground, and background colors is unchanged for K times, then the “YES” branch is taken, and the method proceeds to block 475. If the combination of text, foreground, and background colors has been changed, then the “NO” branch is taken, and the method may end. At block 475, the method may update the previous combination with the current combination of text, foreground, and background colors. In addition, one may be added to the current value of the counter. The method may loop back to decision block 410.

FIG. 5 shows a table 500 for automated menu testing. Each row in table 500 can be a key node with columns text, foreground color, background color, and direction as its attributes. Each row may also depict a test step. Table 500 also includes a column purpose associated with navigating to each key node. Each key node may have one or more of several attributes that include a text string, a foreground color code, a background color code, and a navigation direction. The direction can be horizontal or vertical. Horizontal can be left or right. Vertical can be up or down. A control key is one of an escape key, enter key, up key, down key, left key, and right key. A control key may also be defined by a user according to an operation guide.

FIG. 6 shows table 600 which maps a color to a color code. The mapping may be used in identifying foreground and background colors associated with the target menu. Referring to the first row of table 500, the expected key node includes a text of “Server Mgmt.” with a foreground color of blue and a background color of dark grey. The test case may apply a horizontal key until a current combination of text, foreground, and background colors matches the attributes of the expected key node.

FIG. 7 shows an example of a target menu 700 with a current cursor located at the “Main” top menu element. The Main element may be the initial location of the cursor when the target menu is refreshed. The arrow represents a horizontal direction that the cursor should move to reach the “Server Mgmt.” element as depicted in the first row of table 500 which can also be the first step of the test case. Based on the number of top menu elements, a maximum number of retries may be set to at least seven, as it would take pressing the right key six times to reach the element Server Mgmt.

FIG. 8 shows a text space 800 that includes text associated with the target menu. FIG. 9 shows a foreground space 900 that includes foreground color codes associated with the target menu. FIG. 10 shows a background space 1000 that includes background color codes associated with the target menu. Thus, based on FIGS. 6, 8, 9, and 10, the current location of the cursor has a combination of Main for text with blue for the foreground color and dark grey for the background color. The current combination does not equal the expected combination as shown in the first row of table 500. Accordingly, the cursor may be moved until the expected combination equals the current combination of text, foreground, and background colors or the maximum number of retries is reached.

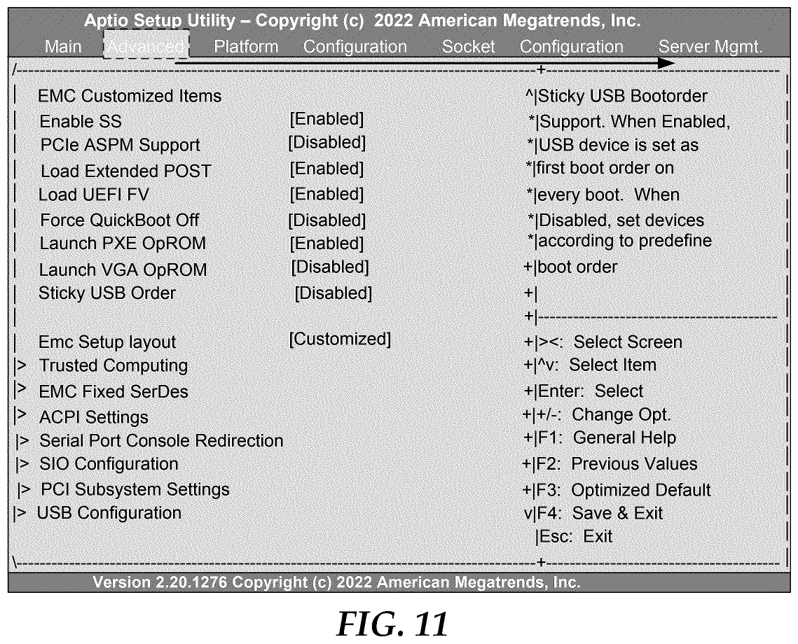

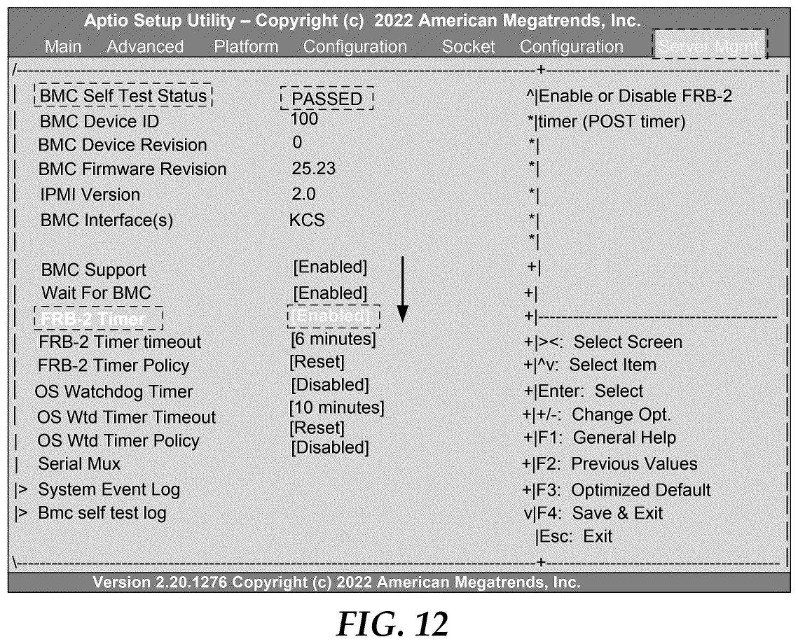

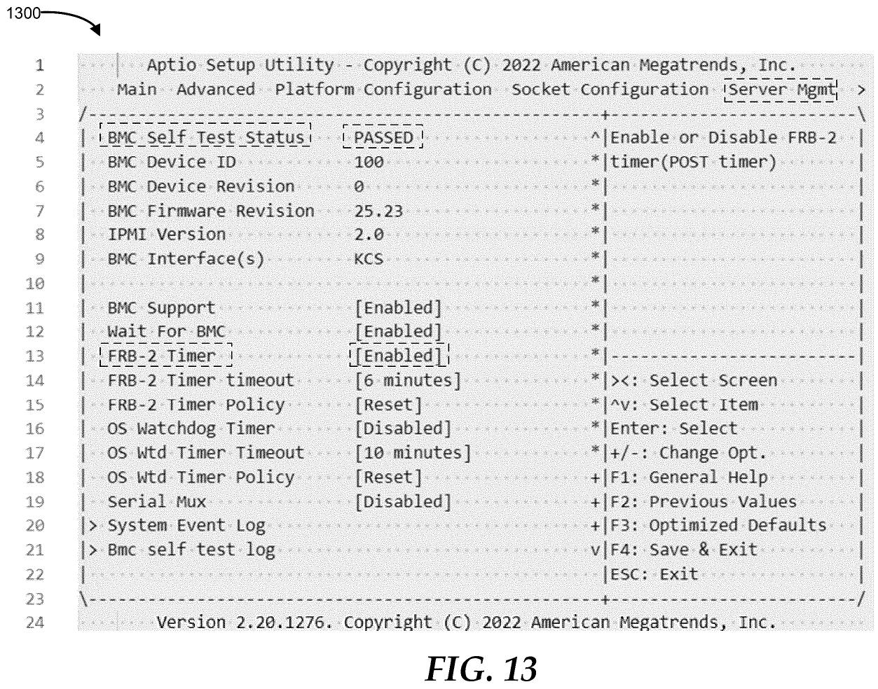

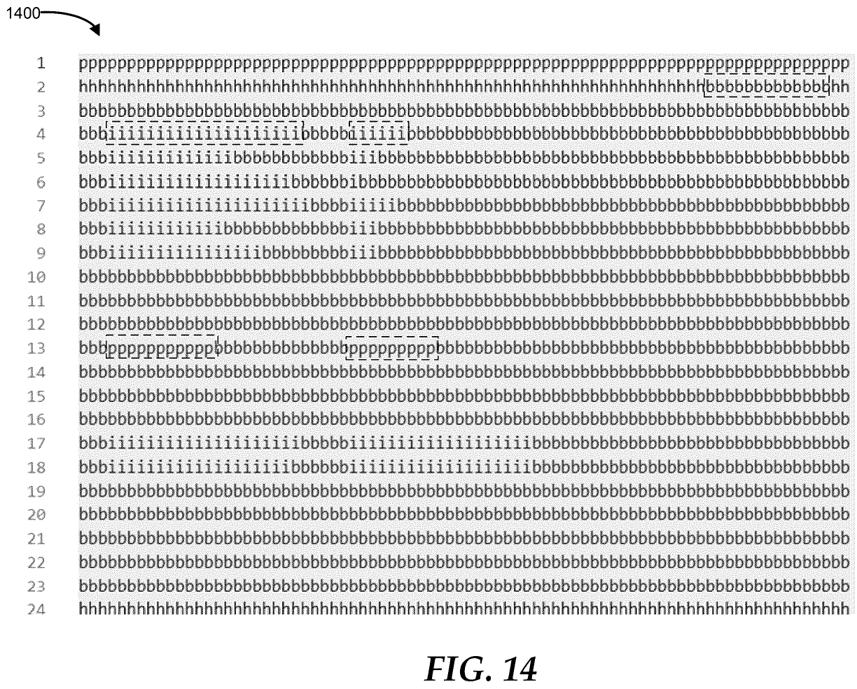

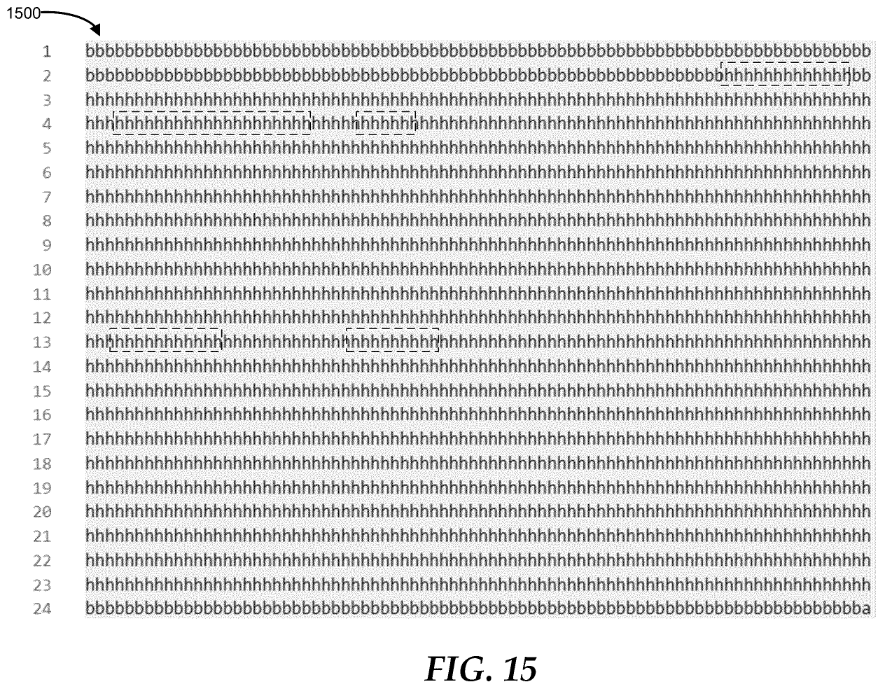

FIG. 11 shows target menu 700 with the cursor located at the “Advanced” top menu element after a right horizontal key has been applied. The right key may have been applied based on the first row of table 500. As such, the cursor moved to the right top menu element next to the Main top menu element. FIG. 12 shows target menu 700 with the current combination associated with the cursor including the text “FRB-2 Timer” with a white foreground color and a background color of dark grey as depicted in FIGS. 13, 14, and 15, respectively. In this example, FIG. 13 shows text in the text space 1300 associated with target menu 700 as depicted in FIG. 12 while FIG. 14 shows a foreground space 1400 that includes foreground color codes associated with target menu 700, and FIG. 15 shows a background space 1500 that includes background color codes associated with target menu 700. In addition, text associated with an element may identify whether the element is selectable or unselected. For example, the “+” associated with the text element “Enabled” indicates that this text element is selectable. The test case may also test for this attribute as depicted in the third row of table 500 of FIG. 5 prior to performing the fourth test step based on the fourth row.

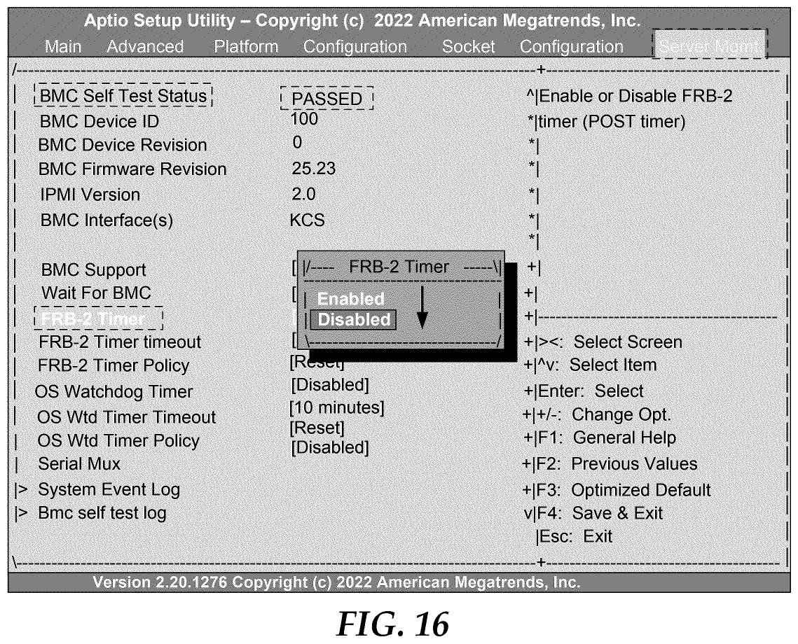

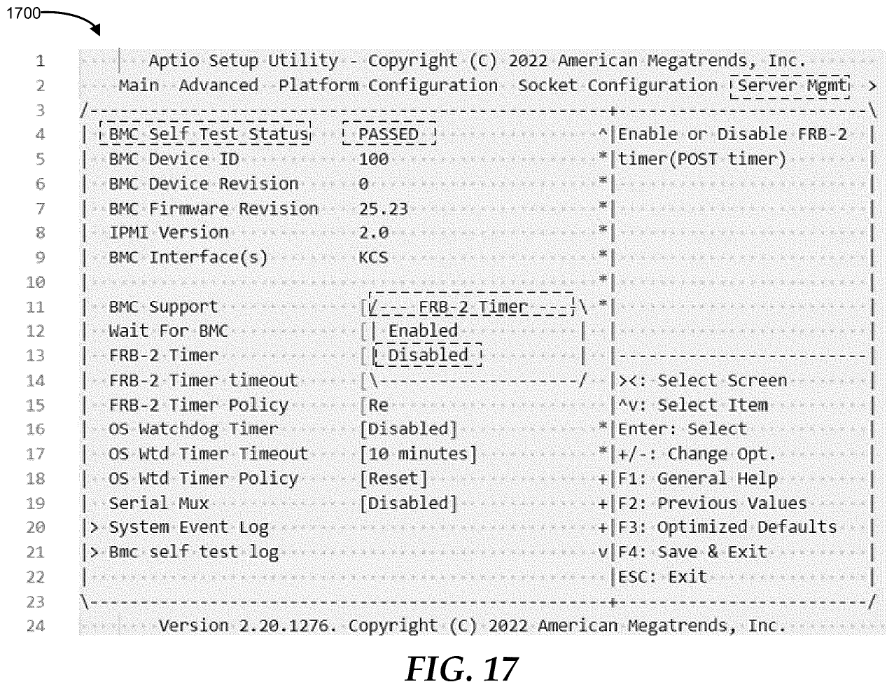

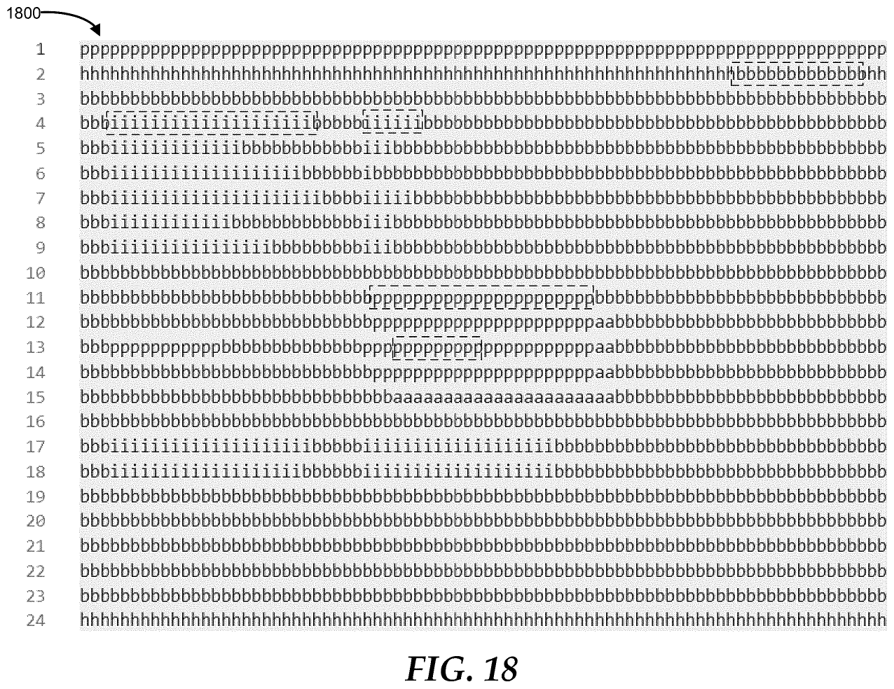

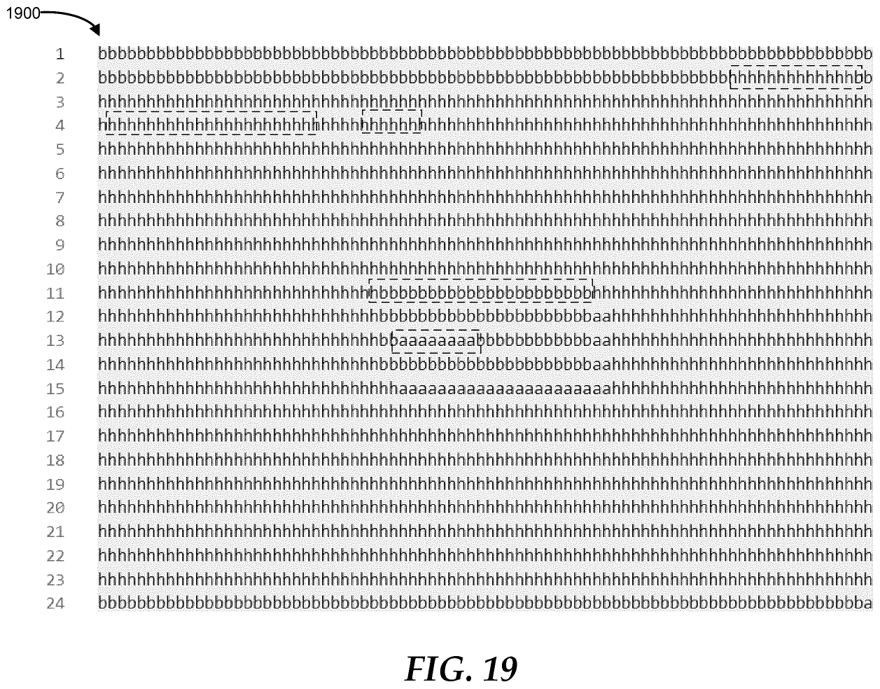

FIG. 16 shows target menu 700 with a sub-menu associated with the text FRB-2 Timer is selected. The arrow depicted in FIG. 16 shows a vertical key has been applied. FIG. 17 shows a text space 1700 that includes text associated with target menu 700 as depicted in FIG. 16 while FIG. 18 shows a foreground space 1800 that includes foreground color codes associated with target menu 700 and FIG. 19 shows a background space 1900 that includes background color codes associated with target menu 700.

Although the cursor is depicted to be located at a default starting position for the test case in the test suite, there may be instances wherein the cursor may be in a non-default position. For example, instead of starting at the Main top menu element, the cursor may be located at the Advanced top menu element. However, based on the first row depicted in table 500 of FIG. 5, the cursor may be moved horizontally to the right, and with each movement, the current combination of attributes associated with the cursor's location may be compared to the expected attributes of a key node. Thus, the cursor may be moved five times to reach the Server Mgmt top menu element which is under the maximum number of retries set for this test step above. Thus, the test case may be successful without modifying the test case for this scenario.

Although FIG. 3, and FIG. 4 show example blocks of method 300 and method 400 in some implementations, method 300 and method 400 may include additional blocks, fewer blocks, different blocks, or differently arranged blocks than those depicted in FIG. 3 and FIG. 4. Those skilled in the art will understand that the principles presented herein may be implemented in any suitably arranged processing system. Additionally, or alternatively, two or more of the blocks of method 300 and method 400 may be performed in parallel. For example, blocks 325, 330, and 335 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
subsequent to initializing, by a processor, a frame buffer associated with a menu, decomposing content of the frame buffer into a text space, a foreground space, and a background space;
navigating the menu to a key node using a control key, wherein the key node includes an expected text and an expected attribute; and
matching a text and an attribute of a current element to the expected text and the expected attribute, wherein the text is from the text space, and wherein the attribute is a foreground color from the foreground space or a background color from the background space.

2. The method of claim 1, wherein the control key includes a navigation key.

3. The method of claim 1, wherein the key node is associated with the control key.

4. The method of claim 1, further comprising if the attribute of the current element does not match the expected attribute of the key node, then applying the control key.

5. The method of claim 4, subsequent to applying the control key, determining whether a maximum number of retries is reached.

6. The method of claim 1, wherein the control key is applied until the key node or a maximum number of retries is reached.

7. The method of claim 1, wherein the matching of the text and the attribute is performed using a regular expression.

8. The method of claim 1, wherein the matching of the text and the attribute of the current element includes matching both an expected background color and an expected foreground color to the background color and the foreground color associated with the current element.

9. An information handling system, comprising:
a processor; and
a memory storing instructions that when executed cause the processor to perform operations including:
subsequent to initializing a frame buffer associated with a menu, decomposing content of the frame buffer into a text space, a foreground space, and a background space;
navigating the menu to a key node using a control key, wherein the key node includes an expected text and an expected attribute; and
matching a text and an attribute of a current element to the expected text and the expected attribute, wherein the text is from the text space, and wherein the attribute is a foreground color from the foreground space or a background color from the background space.

10. The information handling system of claim 9, wherein the control key includes a navigation key.

11. The information handling system of claim 9, wherein the key node is associated with the control key.

12. The information handling system of claim 9, wherein the operations further comprise if the attribute of the current element does not match the expected attribute of the key node, then applying the control key.

13. The information handling system of claim 12, subsequent to applying the control key, determining whether a maximum number of retries is reached.

14. The information handling system of claim 12, wherein the control key is applied until the key node or a maximum number of retries is reached.

15. A non-transitory computer-readable medium to store instructions that are executable to perform operations comprising:
subsequent to initializing a frame buffer associated with a menu, decomposing content of the frame buffer into a text space, a foreground space, and a background space;
navigating the menu to a key node using a control key, wherein the key node includes an expected text and an expected attribute; and
matching a text and an attribute of a current element to the expected text and the expected attribute, wherein the text is from the text space, and wherein the attribute is a foreground color from the foreground space or a background color from the background space.

16. The non-transitory computer-readable medium of claim 15: wherein the control key includes a navigation key.

17. The non-transitory computer-readable medium of claim 15, wherein the key node is associated with the control key.

18. The non-transitory computer-readable medium of claim 15, further comprising if the attribute of the current element does not match the expected attribute of the key node, then applying the control key.

19. The non-transitory computer-readable medium of claim 15, subsequent to applying the control key, determining whether a maximum number of retries is reached.

20. The non-transitory computer-readable medium of claim 19, wherein the control key is applied until the key node or the maximum number of retries is reached.
